(19) United States
(12) Patent Application Publication
(10) Pub. No.: US 2008/0214761 A1
(43) Pub. Date: Sep. 4, 2008

(54) INSULATING FILM FORMING COMPOSITION

(75) Inventors: Kensuke MORITA, Haibara-gun (JP); Makoto MURAMATSU, Haibara-gun (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/041,063

(22) Filed: Mar. 3, 2008

(30) Foreign Application Priority Data
Mar. 2, 2007 (JP) 2007-052632

(51) Int. Cl. C08F 4/04

(52) U.S. Cl. 526/218.1; 526/279

(57) ABSTRACT

An insulating film forming composition, includes: a polymerized substance obtained by dissolving a cage-type silsesquioxane compound having two or more unsaturated groups as substituents in an organic solvent to give a concentration of 12 mass % or less, and polymerizing the cage-type silsesquioxane compound in presence of a polymerization initiator, wherein the polymerized substance obtained by reacting the cage-type silsesquioxane compound having two or more unsaturated groups as substituents totally amounts to 70 mass % or greater of a solid component contained in the insulating film forming composition.

### BACKGROUND OF THE INVENTION

1. Field of the Invention

The present invention relates to an insulating film forming composition, more specifically, a composition which is capable of providing a coated film having an adequately uniform thickness and is useful for the formation of an insulating film excellent in dielectric properties as an interlayer insulating film material in semiconductor devices.

2. Description of the Related Art

Silica (SiO₂) films formed by a vacuum process such as chemical vapor deposition (CVD) have hitherto been used popularly as an interlayer insulating film for use in semiconductor devices. In recent years, application type insulating films composed mainly of a hydrolysate of a tetraalkoxysilane, which are called SOG (Spin On Glass) films, are used in order to form a more uniform interlayer insulating film. Further, with an increase in the integration scale of semiconductor devices, low-dielectric-constant interlayer insulating films composed mainly of a polyorganosiloxane, which are called organic SOG films, are also developed.

Even CVD-SiO₂ films showing a lowest dielectric constant among films made of an inorganic material has however a relative dielectric constant of about 4. SiOF films recently studied as a low-dielectric-constant CVD film have a relative dielectric constant of from about 3.3 to 3.5, but they have drawbacks that their dielectric constant increases during use owing to a high hygroscopic property.

In such situations, there is known a process for forming a film having a reduced dielectric constant by using an organopolysiloxane as an insulating film material excellent in insulation properties, heat resistance and durability and adding thereto a high-boiling-point solvent or thermally decomposable compound to form pores. Although such a film having pores formed therein can have a reduced dielectric constant, it has drawbacks such as deterioration in mechanical strength and increase in dielectric constant due to moisture absorption. It has another drawback that from pores connected to each other, copper used as an interconnect material diffuses in the insulating film.

There is also known an attempt to apply a solution, which has been obtained by adding a low-molecular-weight cage-type compound to an organic polymer, to a substrate, thereby to obtain a film having a low refractive index and low density (refer to Japanese Patent Laid-Open No. 2000-334881). A process of adding a cage-type compound monomer however has drawbacks that it does not have a sufficient effect for reducing the refractive index and dielectric constant and moreover, worsens the surface conditions after application and causes a film thickness loss during baking.

### SUMMARY OF THE INVENTION

An object of the invention is therefore to provide an insulating film forming composition for overcoming the above-described problems, more specifically, an insulating film forming composition capable of providing a film having an adequately uniform thickness and suited for use as an interlayer insulating film in semiconductor devices and moreover, excellent in film properties such as dielectric constant and Young's modulus (the term “insulating film” is also referred to as “dielectric film” and “dielectric insulating film”, but these terms are not substantially distinguished).

It has been found that the above-described object can be accomplished by the following means.

(1) An insulating film forming composition, comprising:

a polymerized substance obtained by dissolving a cage-type silsesquioxane compound having two or more unsaturated groups as substituents in an organic solvent to give a concentration of 12 mass % or less, and polymerizing the cage-type silsesquioxane compound in presence of a polymerization initiator,

wherein the polymerized substance obtained by reacting the cage-type silsesquioxane compound having two or more unsaturated groups as substituents totally amounts to 70 mass % or greater of a solid component contained in the insulating film forming composition.

(2) The insulating film forming composition as described in (1) above,

wherein the polymerization initiator is an azo compound.

(3) The insulating film forming composition as described in (1) or (2) above,

wherein the cage-type silsesquioxane compound which has remained unreacted in the insulating film forming composition amounts to 15 mass % or less.

(4) The insulating film forming composition as described in any of (1) to (3) above,

wherein an organic solvent used for polymerization is an ester-group-containing compound.

(5) The insulating film forming composition as described in any of (1) to (4) above,

wherein the cage-type silsesquioxane compound is a compound having m numbers of RSi (O_{0.5})₃ units, in which m stands for an integer from 8 to 16, and Rs each independently represents a nonhydrolyzable group, with the proviso that at least two of Rs are each a vinyl- or ethynyl-containing group, and

wherein the units are linked to each other via a common oxygen atom and constitute a cage structure.

(6) The insulating film forming composition as described in (5) above,

wherein at least two of Rs are vinyl groups.

(7) The insulating film forming composition as described in (6) above,

wherein Rs are all vinyl groups.

(8) The insulating film forming composition as described in any of (1) to (7) above,

wherein the polymerized substance is substantially free of a component having a molecular weight of 3,000,000 or greater.

### DETAILED DESCRIPTION OF THE INVENTION

The term “insulating film forming composition of the invention (which may hereinafter be called “composition of the invention” simply) is a composition, which comprises a polymerized substance obtained by dissolving, in an organic solvent, a cage-type silsesquioxane compound having two or more unsaturated groups as substituents to give a concentration of 12 mass % or less, and polymerizing the compound in the presence of a polymerization initiator, wherein the polymerized substance obtained by a reaction between the cage-type silsesquioxane compounds each having two or more unsaturated groups as substituents totally amounts to 70 mass % or greater of a solid component of the composition of the invention. (In this specification, mass ratio is equal to weight ratio.)

Examples of the cage-type silsesquioxane compound having two or more unsaturated groups as substituents (which may hereinafter be called “Compound (I)”) include compounds (which may hereinafter be called “Compound (I′)”) having m numbers of RSi(O_{0.5})₃ units (in which m stands for an integer from 8 to 16 and Rs each independently represents a nonhydrolyzable group, with the proviso that at least two of Rs are each a vinyl- or ethynyl-containing group), wherein the units are linked to each other via a common oxygen atom and thereby constitute a cage structure.

From the viewpoint of reducing the dielectric constant, m in the compound (I′) stands for preferably 8, 10, 12, 14 or 16, while it is preferably 8, 10 or 12 from the viewpoint of availability.

The term “cage structure” as used herein means a molecule whose cavity is defined by a plurality of rings formed of covalently bonded atoms and in which all points present inside the cavity cannot leave the cavity without passing through the rings.

Examples of the cage structure represented by the formula (I) are shown in the following. A free bond in the following formulas indicates a bonding site of R.

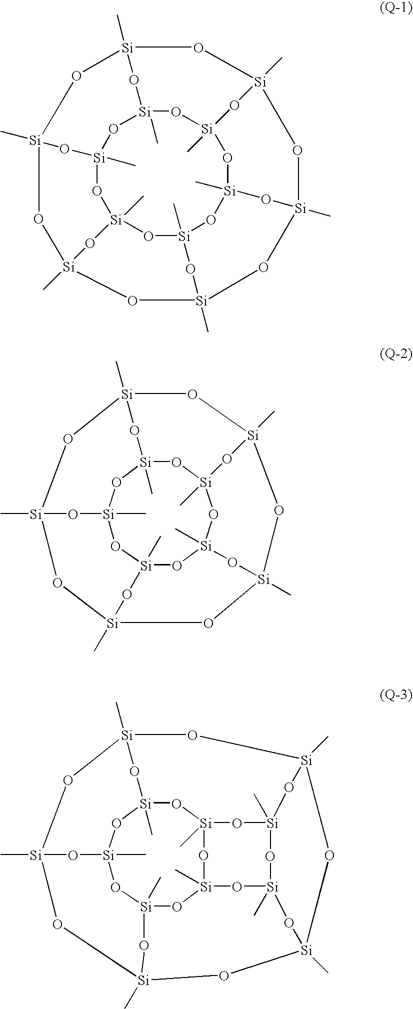

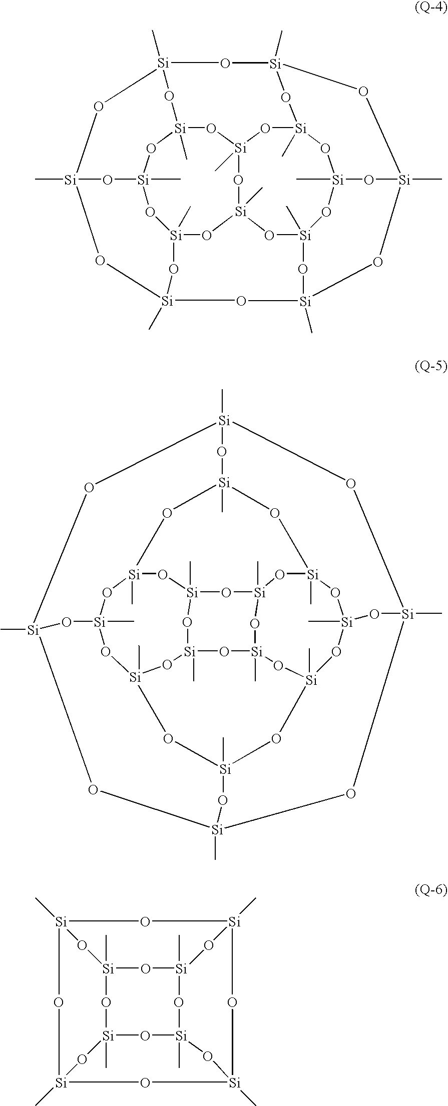

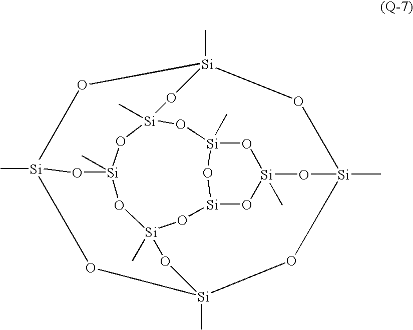

In the compound (I), Rs each indendently represents a nonhydrolyzable group.

The term “nonhydrolyzable group” as used herein means a group at least 95% of which remains without being hydrolyzed when brought into contact with 1 equivalent amount of neutral water at room temperature for one hour. A nonhydrolyzable group at least 99% of which remains without being hydrolyzed under the above conditions is preferred.

At least two of Rs are vinyl- or ethynyl-containing groups. Examples of the nonhydrolyzable group as R include alkyl groups (such as methyl, t-butyl, cyclopentyl and cyclohexyl), aryl groups (such as phenyl, 1-naphthyl and 2-naphthyl), vinyl group, ethynyl group, allyl group, and silyloxy groups (such as trimethylsilyloxy, triethylsilyloxy and t-butyldimethylsilyloxy).

Among the groups represented by Rs, at least two of the groups represented by Rs are vinyl- or ethynyl-containing groups, preferably at least two of the groups represented by Rs are vinyl-containing groups. When the groups represented by Rs contain a vinyl or ethynyl group, the vinyl or ethynyl group is preferably bonded, directly or via a divalent linking group, to a silicon atom to which R is to be bonded. Example of the divalent linking group include —[C(R¹¹) (R¹²)]ₖ—, —CO—, —O—, —N(R¹³)—, —S— and —O—Si(R¹⁴) (R¹⁵)—, and divalent linking groups available using them in any combination. In these formulas, R¹¹ to R¹⁵ each independently represents a hydrogen atom, methyl group, ethyl group or phenyl group and k stands for an integer from 1 to 6. Of these groups, —[C(R¹¹) (R¹²)]ₖ—, —O—, —O—Si(R¹⁴) (R¹⁵)—, and divalent linking groups available using them in any combination are preferred.

In Compound (I), the vinyl or ethynyl group is preferably bonded directly to a silicon atom to which R is to be bonded.

With regard to Rs in Compound (I), it is more preferred that at least two vinyl groups are directly bonded to a silicon atom to which R is to be bonded; still more preferred that at least a half of Rs in Compound (I) are vinyl groups; and especially preferred that Rs are all vinyl groups.

Specific examples of Compound (I) include, but not limited to, the following compounds.

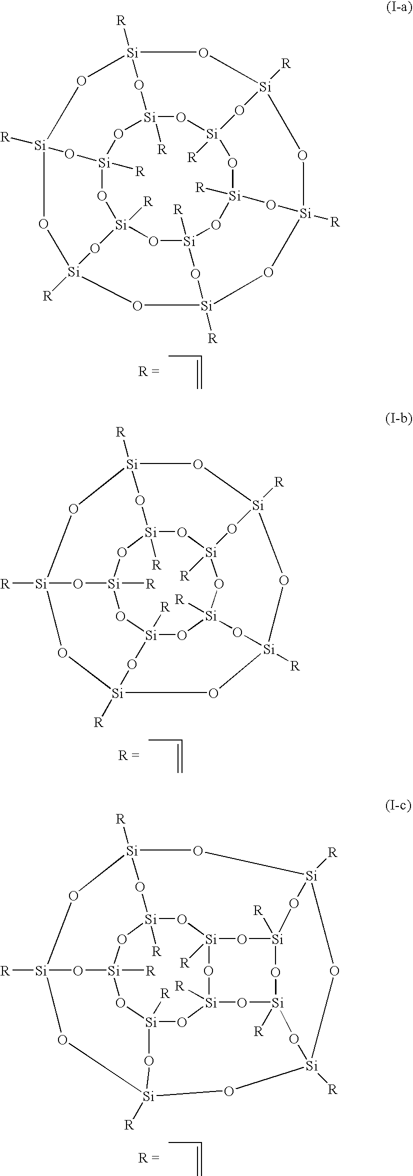

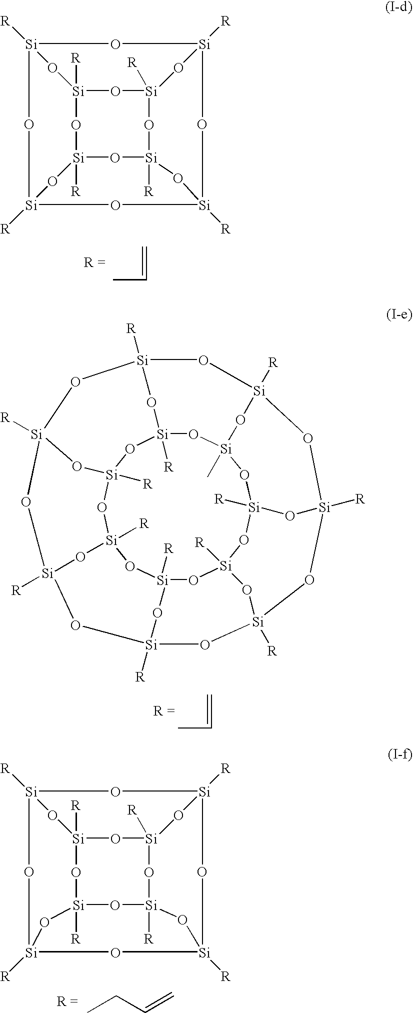

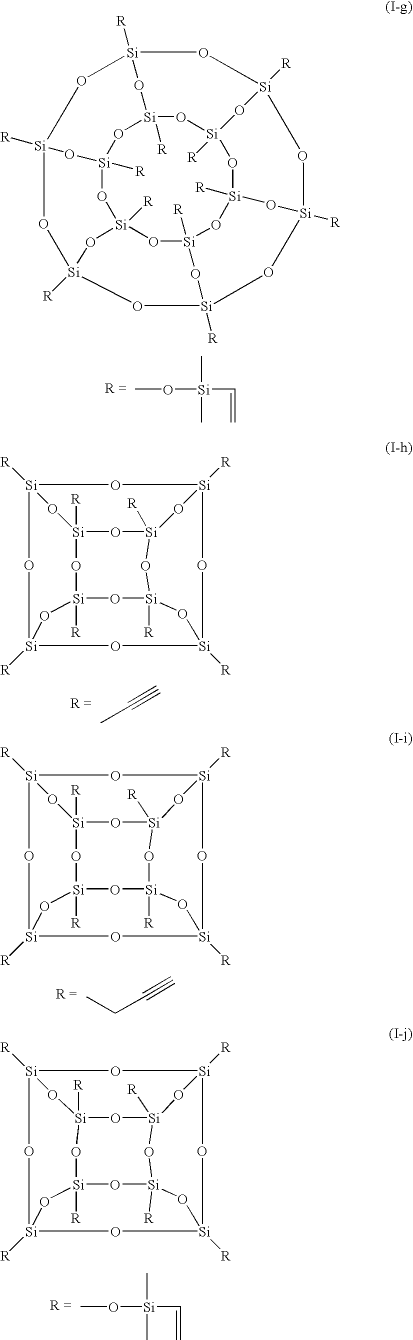

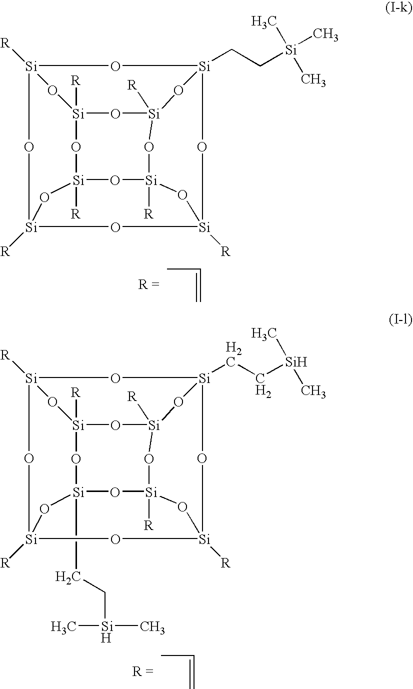

As Compound (1), either a commercially available compound or a compound synthesized in a known manner may be used.

It is also preferred that Rs of Compound (I) of the invention are groups each represented by the following formula (II). In this case, it can be synthesized by reacting a compound represented by the following formula (III) (which will hereinafter be called “Compound (III)”) with a compound represented by the following formula (IV) (which will hereinafter be called “Compound (IV)”).

(R¹)₃—Si—O— (II)

[MO—Si(O_{0.5})₃]ₘ (III)

(R¹)₃—Si—Cl (IV)

The compound (III) can be synthesized, for example, by the process discribed in Angew. Chem. Int. Ed. Engl. 36(7), 743-745(1997).

In the above formulas, R¹s each independently represents a nonhydrolyzable group. Specific examples of the nonhydrolyzable group as R¹ include alkyl groups, aryl groups, vinyl group and ethynyl group, and m has the same meaning as in Compound (I′). M represents a metal atom (for example, Na, K, Cu, Ni or Mn) or an onium cation (for example, tetramethylammonium). When M represents a polyvalent metal atom, a plurality of —O—Si(O_{0.5})₃s are bonded to the polyvalent metal atom M.

The reaction between the compound (III) with the compound (IV) is performed, for example, typically at from 0 to 180° C. for from 10 minute to 20 hours under stirring while adding the compound (III) and from 1 to 100 moles, per mole of the Si—OM groups contained in the compound (III), of the compound (IV) to a solvent.

As the solvent, organic solvents such as toluene, hexane, and tetrahydrofuran (THF) are preferred.

When the compound (III) is reacted with the compound (IV), a base such as triethylamine or pyridine may be added.

The composition of the invention may contain a polymerized substance of two or more different Compounds (I). In this case, it may be a copolymer composed of two or more different Compounds (I) or a mixture of homopolymers. When the composition of the invention contains a copolymer composed of two or more different Compounds (I), the copolymer is preferably that of a mixture of two or more Compounds (I′) selected from respective compounds (I′) having 8, 10 and 12 as m.

The polymer contained in the composition of the invention may be a copolymerized substance with a compound other than Compound (I). In this case, the compound preferably has a plurality of polymerizable carbon-carbon unsaturated bonds or SiH groups. Preferred examples of such a compound include vinylsilanes, vinylsiloxanes, phenylacetylenes and [(HSiO_{0.5})₃]₈.

In this case, components derived from Compound (I) preferably amount to 70 mass % or greater, more preferably 80 mass % or greater, most preferably 90 mass % or greater of the copolymerized substance.

The composition of the invention may be either in the solution form having the polymer (reaction product)of Compounds (I) dissolved in an organic solvent or in the solid form containing the reaction product of Compounds (I).

Of the solid component contained in the composition of the invention, the total amount of the polymerized substance obtained by the reaction between Compounds (I) is preferably 70 mass % or greater, more preferably 80 mass % or greater, still more preferably 90 mass % or greater, most preferably 95 mass % or greater.

The greater the content of it in the solid component, a film having a lower dielectric constant can be formed.

The term “solid component” as used herein means all the components contained in the composition excluding a volatile component. The volatile component include components which vaporize after decomosition into low-molecular compounds. Examples of the volatile component include water, organic solvents and volatile additives.

Examples of the components contained in the solid component of the invention excluding the polymerized substance obtained by the reaction between Compounds (I) include Compound (I), components other than the reaction product of Compound (I) contained in the copolymerized substance containing the reaction product of Compound (I), and nonvolatile additives.

The amount of Compound (I) can be determined using a GPC chart, HPLC chart, NMR spectrum, UV spectrum or IR spectrum of the solid component. Amounts of the components in the copolymerized substance can be sometimes determined from their charged ratios, but can also be determined by subjecting the solid component, which has been purified if necessary, to NMR spectrum, UV spectrum, IR spectrum or elemental analysis.

The amount of the nonvolatile additive can be determined by using the amount of it added to the composition as an amount present in the solid component or from a GPC chart or HPLC chart of the solid component. It can also be determined by subjecting the solid component, which has been purified if necessary, to NMR spectrum, UV spectrum, IR spectrum or elemental analysis.

The solid component excluding them is the polymerized substance obtained by the reaction between Compounds (I).

In order to obtain a film having good surface conditions after application and not undergoing a film thickness loss during baking, the amount of the compound (I) which has remained unreacted in the solid component of the composition of the invention is preferably smaller.

The amount of the compound (I) in the solid component is 15 mass % or less, preferably 10 mass % or less, most preferably 5 mass % or less.

A portion, in the GPC chart, of the solid component contained in the composition of the invention excluding Compound (I) has a number-average molecular weight (Mn) of from 20,000 to 200,000, more preferably from 25,000 to 150,000, most preferably from 30,000 to 100,000.

A film having a lower dielectric constant can be formed when the number-average molecular weight is greater.

In the invention, GPC was performed using “Waters 2695” and a GPC column “KF-805L” (trade name; product of Shodex) and, as an eluting solvent, tetrahydrofuran at a flow rate of 1 ml/min while setting a column temperature at 40° C.; injecting 50 μl of a tetrahydrofuran solution having a sample concentration of 0.5 mass %; and drawing a calibration curve for the monomer by utilizing an integrated value of an RI detector (“Waters 2414”) to determine the amount of the monomer in the solid component. The Mn, Mw and M_{z+1} were values calculated based on a calibration curve drawn using standard polystyrene.

The (Z+1) average molecular weight (M_{z+1}) of the portion, in the GPC chart, of the solid component contained in the composition of the invention excluding Compound (I) is preferably form 90,000 to 600,000, more preferably from 120,000 to 450,000, most preferably from 150,000 to 300,000.

Greater (Z+1) average molecular weights lead to deterioration in solubility in an organic solvent and filtration properties through a filter, each of the resulting composition, which may cause deterioration of surface properties of a coated film.

A composition having good solubility in an organic solvent and good filteration properties through a filter, and capable of providing a coated film having good surface conditions and a low dielectcric constant is available when these average molecular weights fall within the above-described ranges.

The portion, in the GPC chart, of the solid component contained in the composition of the invention excluding the Compound (I) monomer has MW of preferably from 30,000 to 210,000, more preferably from 40,000 to 180,000, most preferably from 50,000 to 160,000.

From the viewpoints of solubility in an organic solvent, filterability through a filter and surface conditions of a coated film, the polymer of the invention is preferably substantially free of components having a molecular weight of 3,000,000 or greater, more preferably substantially free of components having a molecular weight of 2,000,000 or greater, most preferably free of components having a molecular weight of 1,000,000 or greater.

In the solid component of the composition of the invention, preferably from 10 to 90 mole %, more preferably from 20 to 80 mole %, most preferably from 30 to 70 mole % of the vinyl or ethynyl groups of Compound (I) remain unreacted.

To the polymer (reaction product) of Compound (I) in the composition of the invention, from 0.1 to 40 mass %, more preferably from 0.1 to 20 mass %, still more preferably from 0.1 to 10 mass %, most preferably from 0.1 to 5 mass % of the polymerization initiator, additive or polymerization solvent may be bonded.

The amount of them may be determined by the NMR spectrum of the composition.

For preparation of the composition of the invention, Compound (I) is prepared preferably by utilizing a polymerization reaction between carbon-carbon unsaturated bonds.

It is especially preferred to dissolve Compound (I) in a solvent and then adding thereto a polymerization initiator to cause a reaction of a vinyl or ethynyl group.

Any polymerization reaction can be employed and examples include radical polymerization, cationic polymerization, anionic polymerization, ring-opening polymerization, polycondensation, polyaddition, addition condensation and polymerization in the presence of a transition metal catalyst.

The amount of Compound (I) which has remained at the time of completion of the polymerization reaction is preferably 25 mass % or less, more preferably 20 mass % or less, most preferably 15 mass % or less based on the addition amount of it. When these conditions are satisfied during polymerization, a film forming composition capable of providing a coated film having good surface conditions and undergoing a small film thickness loss during baking can be prepared in high yield.

The polymer has a weight average molecular weight (Mw), at the time of completion of the polymerization reaction, of preferably from 30,000 to 160,000, more preferably from 40,000 to 140,000, most preferably from 50,000 to 120,000.

The polymer has a (Z+1) average molecular weight (M_{z+1}), at the time of completion of the polymerization reaction, of preferably from 90,000 to 700,000, more preferably from 120,000 to 550,000, most preferably from 150,000 to 400,000.

The polymer at the time of completion of the polymerization reaction is preferably substantially free of components having a molecular weight of 3,000,000 or greater, more preferably substantially free of components having a molecular weight of 2,000,000 or greater, most preferably free of components having a molecular weight of 1,000,000 or greater.

When these molecular weight conditions are satisfied at the time of polymerization, a film forming composition soluble in an organic solvent, having good filterability through a filter and capable of providing a film with a low dielectric constant can be prepared.

In order to satisfy the above-described molecular weight conditions, the concentration of Compound (I) during the polymerization reaction is preferably 12 mass % or less, more preferably 10 mass % or less, still more preferably 8 mass % or less, most preferably 6 mass % or less.

The productivity at the time of the reaction is better when the concentration of Compound (I) at the time of the polymerization is higher. In this sense, the concentration of Compound (I) is preferably 0.1 mass % or greater, more preferably 1 mass % or greater at the time of the polymerization.

In the preparation process of the composition of the invention, the polymerization of Compound (I) is preferably followed by treatment such as removal of high molecular components by filtration or centrifugation, or purification by column chromatography.

In particular, it is preferred, as a preparation process of the composition of the invention, to subject the solid formed by the polymerization reaction to re-precipitation treatment to remove therefrom low molecular components and remaining Compound (I), thereby increasing the Mn and reducing the remaining amount of Compound (I).

The term “re-precipitation treatment” as used herein means collection, by filtration, of the composition of the invention which has been precipitated by adding a poor solvent (a solvent which does not substantially dissolve the composition of the invention therein) to the reaction mixture from which the reaction solvent has been distilled off as needed, adding dropwise the reaction mixture, from which the reaction solvent has been distilled off as needed, to a poor solvent, or dissolving the solid component in a good solvent and then adding the poor solvent to the resulting solution.

Examples of the good solvent include ethyl acetate, butyl acetate, toluene, methyl ethyl ketone and tetrahydrofuran. As the poor solvent, alcohols (methanol, ethanol and isopropyl alcohol), hydrocarbons (hexane and heptane) and water are preferred. The good solvent is used in an amount of preferably from 1 time to 50 times the mass, preferably from 2 times to 20 times the mass of the composition of the invention, while the poor solvent is used in an amount of preferably from 1 time to 200 times the mass, more preferably from 2 times to 50 times the mass of the composition of the invention.

The polymerization reaction of Compound (I) is performed in the presence of a non-metal polymerization initiator. For example, it can be polymerized in the presence of a polymerization initiator showing activity while generating a free radical such as carbon radical or oxygen radical by heating.

As the polymerization initiator, organic azo compounds are usable.

Preferred examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, azoamidine compounds such as “V-50” and VA-057”, azoester compounds such as “VA-601” (each, trade name, commercially available from Wako Pure Chemical Industries), 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutyronitrile), 1,1-azobis(cyclohexane-1-carbonitrile), 1-[(1-cyano-1-methylethyl)azo]formamide, 2,2-azobis{2-methyl-N-[1,1-bis(hydroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazolin-2-yl)propane]dihydrochloride, 2,2-azobis[2-(2-imidazolin-2-yl)]propane]disulfate dihydrate, 2,2-azobis{2-[1-(2-hydroxyethyl)-2-imidazolin-2-yl]propane}dihydrochloride, 2,2-azobis[2-[2-imidazolin-2-yl]propane], 2,2-azobis(1-imino-1-pyrrolidino-2-methylpropane)dihydrochloride, 2,2-azobis(2-methylpropionamidine)dihydrochloride, 2,2-azobis[N-(2-carboxyethyl)-2-methylpropionamidine]tetrahydrate, dimethyl-2,2-azobis(2-methylpropionate), 4,4-azobis(4-cyanovaleric acid) and 2,2-azobis(2,4,4-trimethylpentane).

As the polymerization initiator, organic azo compounds are used in consideration of the safety as a reagent itself and reproducibility of the molecular weight in the polymerization reaction. Of these, azo ester compounds such as “V-601” are most preferred because a harmful cyano group is not incorporated in the polymer.

A ten-hour half-life temperature of the polymerization initiator is preferably 100° C. or less. When the ten-hour half-life temperature is 100° C. or less, remaining of the polymerization initiator upon completion of the reaction can be avoided easily.

In the invention, the polymerization initiators may be used either singly or in combination.

The amount of the polymerization initiator(s) is preferably from 0.0001 to 2 moles, more preferably from 0.003 to 1 mole, especially preferably from 0.001 to 0.5 mole per mole of the monomer.

As the solvent to be used in the polymerization reaction, any solvent is usable insofar as it can dissolve Compound (I) therein at a required concentration and has no adverse effect on the properties of a film formed from the polymer. In the following description, the term “ester solvent”, for example, means a solvent having in the molecule thereof an ester group.

Examples include water, alcohol solvents such as methanol, ethanol and propanol, ketone solvents such as alcohol acetone, methyl ethyl ketone, methyl isobutyl ketone, cyclohexanone and acetophenone; ester solvents such as methyl acetate, ethyl acetate, propyl acetate, isopropyl acetate, butyl acetate, pentyl acetate, hexyl acetate, methyl propionate, ethyl propionate, propylene glycol monomethyl ether acetate, γ-butyrolactone and methyl benzoate; ether solvents such as dibutyl ether, anisole and tetrahydrofuran; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane. Of these, more preferred are ester solvents, of which methyl acetate, ethyl acetate, propyl acetate, isopropyl acetate, butyl acetate, pentyl acetate, hexyl acetate, methyl propionate, ethyl propionate, propylene glycol monomethyl ether acetate, γ-butyrolactone, and methyl benzoate are more preferred, with ethyl acetate and butyl acetate being especially preferred.

These solvents may be used either singly or in combination.

The organic solvent has preferably a boiling point of 75° C. or greater but not greater than 140° C. in order to heat the reaction mixture to a temperature necessary for decomposing the polymerization initiator at the time of reaction and distill off the organic solvent after completion of the reaction.

In the invention, the polymerization initiator may be added all at once, in portions or continuously. The latter two methods are preferred because they enable an increase in the molecular weight and in addition, are advantageous from the viewpoint of the film strength.

It is especially preferred from the viewpoint of film strength and reproducibility of the molecular weight at the time of the polymerization reaction to add the polymerization initiator in portions or continuously while keeping the reaction mixture composed of Compound (I) and organic solvent at the one-hour half-life temperature or greater of the polymerization initiator.

The conditions most suited for the polymerization reaction in the invention differ, depending on the kind or concentration of the polymerization initiator, monomer or solvent. The polymerization reaction is performed preferably at an inner temperature of from 0 to 200° C., more preferably from 40 to 170° C., especially preferably from 70 to 140° C. for a period of preferably from 1 to 50 hours, more preferably from 2 to 20 hours, especially preferably from 3 to 10 hours.

To suppress the inactivation of the polymerization initiator which will otherwise occur by oxygen, the reaction is performed preferably in an inert gas atmosphere (for example, nitrogen or argon). The oxygen concentration upon reaction is preferably 100 ppm or less, more preferably 50 ppm or less, especially preferably 20 ppm or less.

The composition of the invention is preferably soluble in an organic solvent. The term “soluble in an organic solvent” as used herein means that 5 mass % or greater of the composition of the invention dissolves at 25° C. in a solvent selected from cyclohexanone, methyl ethyl ketone, methyl isobutyl ketone, propylene glycol monomethyl ether acetate, propylene glycol monomethyl ether and γ-butyrolactone. Preferably 10 mass % or greater, more preferably 20 mass % or greater of the composition dissolves in the solvent.

When the composition of the invention is prepared, the reaction mixture after the polymerization reaction of Compound (I) may be used as is as the composition of the invention but it is preferred to distill and concentrate the reaction mixture to remove the reaction solvent and use the concentrate as the composition. It is also preferred to use it after re-precipitation treatment.

The reaction mixture is concentrated preferably by heating and/or pressure reduction in a rotary evaporator, distiller or reaction apparatus used for the polymerization reaction. The temperature of the reaction mixture at the time of concentration is typically from 0 to 180° C., preferably from 10 to 140° C., more preferably from 20 to 100° C., most preferably from 30 to 60° C. The pressure at the time of concentration is typically from 0.133 Pa to 100 kPa, preferably from 1.33 Pa to 13.3 kPa, more preferably from 1.33 Pa to 1.33 kPa.

When the reaction mixture is concentrated, it is concentrated until the solid content in the reaction mixture reaches preferably 10 mass % or greater, more preferably 30 mass % or greater, most preferably 50 mass % or greater.

To the composition of the invention or during the preparation of the composition, a polymerization inhibitor may be added to suppress excessive polymerization. Examples of the polymerization inhibitor include 4-methoxyphenol and catechol.

In the invention, it is preferred that the polymer of Compound (I) is dissolved in an appropriate solvent and then the resulting solution is applied to a substrate. Examples of the usable solvent include ethylene dichloride, cyclohexanone, cyclopentanone, 2-heptanone, methyl isobutyl ketone, γ-butyrolactone, methyl ethyl ketone, methanol, ethanol, dimethylimidazolidinone, ethylene glycol monomethyl ether, ethylene glycol monoethyl ether, ethylene glycol dimethyl ether, 2-methoxyethyl acetate, ethylene glycol monoethyl ether acetate, propylene glycol monomethyl ether (PGME), propylene glycol monomethyl ether acetate (PGMEA), tetraethylene glycol dimethyl ether, triethylene glycol monobutyl ether, triethylene glycol monomethyl ether, isopropanol, ethylene carbonate, ethyl acetate, butyl acetate, methyl lactate, ethyl lactate, methyl methoxypropionate, ethyl ethoxypropionate, methyl pyruvate, ethyl pyruvate, propyl pyruvate, N,N-dimethylformamide, dimethylacetamide, dimethylsulfoxide, N-methylpyrrolidone, tetrahydrofuran, diisopropylbenzene, toluene, xylene, and mesitylene. These solvents may be used either singly or as a mixture.

Of these, preferred are propylene glycol monomethyl ether acetate, propylene glycol monomethyl ether, 2-heptanone, cyclohexanone, γ-butyrolactone, ethylene glycol monomethyl ether, ethylene glycol monoethyl ether, ethylene glycol monoethyl ether acetate, propylene glycol monomethyl ether, propylene glycol monoethyl ether, ethylene carbonate, butyl acetate, methyl lactate, ethyl lactate, methyl methoxypropionate, ethyl ethoxypropionate, N-methylpyrrolidone, N,N-dimethylformamide, tetrahydrofuran, methyl isobutyl ketone, xylene, mesitylene and diisopropylbenzene.

A solution obtained by dissolving the composition of the invention in an appropriate solvent is also embraced in the scope of the composition of the invention. A total solid concentration in the solution of the invention is preferably from 1 to 30 mass % and is regulated as needed according to the purpose of use. When the total solid concentration of the composition is within a range of from 1 to 30 mass %, the thickness of a coated film falls within an appropriate range, and a coating solution has better storage stability.

The composition of the invention may contain a polymerization initiator, but the composition not containing a polymerization initiator is preferred because it has better storage stability.

When the composition of the invention must be cured at a low temperature, however, it preferably contains a polymerization initiator. In such a case, polymerization initiators similar to those cited above can be employed. Also an initiator which induces polymerization by radiation may also be utilized for this purpose.

The content of metals, as an impurity, of the composition of the invention is preferably as small as possible. The metal content of the composition can be measured with high sensitivity by ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting step raises the dielectric constant of the film obtained by the invention. The metal content is preferably 10 ppm or less, more preferably 1 ppm or less, especially preferably 100 ppb or less.

The metal concentration of the composition can also be evaluated by subjecting a film obtained using the composition of the invention to total reflection fluorescent X-ray analysis. When W ray is employed as an X-ray source, metal elements such as K, Ca, Ti, Cr, Mn, Fe, Co, Ni, Cu, Zn, and Pd can be observed. Their concentration is preferably from 100×10¹⁰ cm⁻² or less, more preferably 50×10¹⁰ cm⁻² or less, especially preferably 10×10¹⁰ cm⁻² or less. In addition, Br, that is, a halogen can also be observed. Its remaining amount is preferably 10000×10¹⁰ cm⁻² or less, more preferably 1000×10 cm⁻² or less, especially preferably 400×10¹⁰ cm⁻² or less. Moreover, Cl can also be observed as a halogen. In order to prevent it from damaging a CVD device, etching device or the like, its remaining amount is preferably 100×10¹⁰ cm⁻² or less, more preferably 50×10¹⁰ cm⁻² or less, especially preferably 10×10¹⁰ cm⁻² or less.

To the composition of the invention, additives such as radical generator, colloidal silica, surfactant, silane coupling agent and adhesive agent may be added without impairing the properties (such as heat resistance, dielectric constant, mechanical strength, coatability, and adhesion) of an insulating film obtained using it.

Any colloidal silica may be used in the invention. For example, a dispersion obtained by dispersing high-purity silicic anhydride in a hydrophilic organic solvent or water and having typically an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants may be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film-forming coating solution.

The term “silicone surfactant” as used herein means a surfactant containing at least one Si atom. Any silicone surfactant may be used in the invention, but it has preferably a structure containing an alkylene oxide and dimethylsiloxane, more preferably a structure containing the following chemical formula:

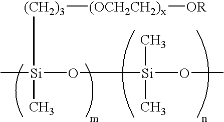

In the above formula, R¹ represents a hydrogen atom or a C₁₋₅ alkyl group, x stands for an integer from 1 to 20, and m and n each independently represents an integer from 2 to 100. A plurality of R¹s may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Corning Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (meth)acrylic acid copolymers.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. In the invention, these silane coupling agents may be used either singly or in combination.

In the invention, any adhesion promoter may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. Functional silane coupling agents are preferred as an adhesion promoter. The amount of the adhesion promoter is preferably 10 parts by mass or less, especially preferably from 0.05 to 5 parts by mass, based on 100 parts by mass of the total solid content.

In order to obtain a film having a reduced dielectric constant, it is also possible to form a porous film by using a pore forming factor to the extent permitted by the mechanical strength of the film.

Although no particular limitation is imposed on the pore forming factor as an additive to serve as a pore forming agent, a non-metallic compound is preferred. It must satisfy both the solubility in a solvent to be used for a film-forming coating solution and compatibility with the polymer of the invention.

As the pore forming agent, polymers are usable. Examples of the polymer usable as the pore forming agent include polyvinyl aromatic compounds (such as polystyrene, polyvinylpyridine and halogenated polyvinyl aromatic compounds), polyacrylonitrile, polyalkylene oxides (such as polyethylene oxide and polypropylene oxide), polyethylene, polylactic acid, polysiloxane, polycaprolactone, polycaprolactam, polyurethane, polymethacrylates (such as polymethyl methacrylate), polymethacrylic acid, polyacrylates (such as polymethyl acrylate), polyacrylic acid, polydienes (such as polybutadiene and polyisoprene), polyvinyl chloride, polyacetal and amine-capped alkylene oxides. In addition, also usable are polyphenylene oxide, poly(dimethylsiloxane), polytetrahydrofuran, polycyclohexylethylene, polyethyloxazoline, polyvinylpyridine and polycaprolactone.

In particular, the polystyrene is suited as the pore forming agent. As the polystyrene, anionically polymerized polystyrene, syndiotactic polystyrene, and unsubstituted or substituted polystyrene (for example, poly(α-methylstyrene)) are usable, of which unsubstituted polystyrene is preferred.

As the pore forming gent, thermoplastic polymers are also usable. Examples of the thermoplastic pore forming polymer include polyacrylates, polymethacrylates, polybutadiene, polyisoprene, polyphenylene oxide, polypropylene oxide, polyethylene oxide, poly(dimethylsiloxane), polytetrahydrofuran, polyethylene, polycyclohexylethylene, polyethyloxazoline, polycaprolactone, polylactic acid and polyvinyl pyridine.

The boiling point or decomposition point of the pore forming agent is preferably from 100 to 500° C., more preferably from 200 to 450° C., especially preferably from 250 to 400° C. The molecular weight of it is preferably from 200 to 50,000, more preferably from 300 to 10,000, especially preferably from 400 to 5,000.

The amount of it in terms of mass % is preferably from 0.5 to 75%, more preferably from 0.5 to 30%, especially preferably from 1 to 20% relative to the film forming polymer.

The polymer may contain a decomposable group as the pore forming factor. The decomposition point of it is preferably from 100 to 500° C., more preferably from 200 to 450° C., especially preferably from 250 to 400° C. The content of the decomposable group is, in terms of mole %, from 0.5 to 75%, more preferably from 0.5 to 30%, especially preferably from 1 to 20% relative to the film forming polymer.

The film forming composition of the invention is used for film formation preferably after elimination therefrom of insoluble matters, gel-like components and the like by filtration through a filter. The filter to be used for such a purpose preferably has a pore size of from 0.001 to 0.2 μm, more preferably from 0.005 to 0.05 μm, most preferably from 0.005 to 0.03 μm. The filter is made of preferably PTFE, polyethylene or nylon, more preferably polyethylene or nylon.

A film available using the film forming composition of the invention can be formed by applying the film forming composition onto a substrate such as silicon wafer, SiO₂ wafer, SiN wafer, glass or plastic film by a desired method such as spin coating, roller coating, dip coating, scan coating, spraying, or bar coating, and then heating to remove the solvent if necessary. As a method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate. When the solution of the composition is discharged, either dynamic discharge in which the solution of the composition is discharged onto a rotating substrate or static discharge in which the solution of the composition is discharged onto a static substrate may be employed. The dynamic discharge is however preferred in view of the in-plane uniformity of the film. Alternatively, from the viewpoint of reducing the consumption amount of the composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge of the substrate. The heat treatment method is not particularly limited, but ordinarily employed methods such as hot plate heating, heating with a furnace, heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “α series” (trade name; product of Tokyo Electron) is preferred.

It is especially preferred to apply the polymer of the invention onto a substrate, followed by heating to cure it. Curing of the film means hardening of the composition on the substrate to give a solvent resistance to the film. For curing, heat treatment (baking) is especially preferred. For this purpose, the polymerization reaction, at the time of post heating, of vinyl groups remaining in the polymer may be utilized. The post heat treatment is performed preferably at a temperature of from 100 to 450° C., more preferably from 200 to 420° C., especially preferably from 350 to 400° C. for a period of preferably from 1 minute to 2 hours, more preferably from 10 minutes to 1.5 hours, especially preferably from 30 minutes to 1 hour. The post heat treatment may be performed in several times. This post heat treatment is performed especially preferably in a nitrogen atmosphere in order to prevent thermal oxidation due to oxygen.

In the invention, curing may be accomplished not by heat treatment but by exposure to high energy radiation to cause the polymerization reaction of vinyl or ethynyl groups remaining in the polymer. Examples of the high energy radiation include, but not limited to, an electron beam, ultraviolet ray and X ray.

When an electron beam is employed as high energy radiation, the energy is preferably from 0 to 50 keV, more preferably from 0 to 30 keV, especially preferably from 0 to 20 keV. Total dose of the electron beam is preferably from 0 to 5 μC/cm², more preferably from 0 to 2 μC/cm², especially preferably from 0 to 1 μC/cm². The substrate temperature when it is exposed to the electron beam is preferably from 0 to 450° C., more preferably from 0 to 400° C., especially preferably from 0 to 350° C. Pressure is preferably from 0 to 133 kPa, more preferably from 0 to 60 kPa, especially preferably from 0 to 20 kPa. The atmosphere around the substrate is preferably an atmosphere of an inert gas such as Ar, He or nitrogen from the viewpoint of preventing oxidation of the polymerized substance of the invention. An oxygen, hydrocarbon or ammonia gas may be added for the purpose of causing a reaction with plasma, electromagnetic wave or chemical species generated by the interaction with the electron beam. In the invention, exposure to the electron beam may be carried out in plural times. In this case, the exposure to the electron beam is not necessarily carried out under the same conditions but the conditions may be changed every time.

An ultraviolet ray may be employed as high energy radiation. The radiation wavelength range of the ultraviolet ray is preferably from 190 to 400 nm, while its output immediately above the substrate is preferably from 0.1 to 2,000 mWcm⁻². The substrate temperature upon exposure to the ultraviolet ray is preferably from 250 to 450° C., more preferably from 250 to 400° C., especially preferably from 250 to 350° C. As the atmosphere around the substrate, an atmosphere of an inert gas such as Ar, He or nitrogen is preferred from the viewpoint of preventing oxidation of the polymerized substance of the invention. The pressure at this time is preferably from 0 to 133 kPa.

The film may also be cured by carrying out heat treatment and exposure to high energy radiation simultaneously or successively.

When an insulating film is formed, a film having a thickness, in terms of dried film thickness, of from 0.05 to 1.5 μm can be formed by single application and a film having a thickness of from about 0.1 to 3 μm can be formed by double application.

In order to prevent decomposition of the cage structure during baking, it is preferred that a group (such as hydroxyl group or silanol group) nucleophilically attacking Si atoms during the preparation of the composition or formation of the insulating film is substantially absent.

Described specifically, a low-dielectric-constant insulating film can be formed by applying the composition of the invention onto a substrate (typically a substrate having metal interconnects), for example, by spin coating, drying off the solvent by preliminary heat treatment, and then carrying out final heat treatment (annealing) at a temperature of 300° C. or greater but not greater than 430° C.

When the film obtained using the film forming composition of the invention is used as an interlayer insulating film for semiconductor, a barrier layer for preventing metal migration may be disposed on the side surfaces of an interconnect. As well as a cap layer, an interlayer adhesion layer or the like for preventing peeling during CMP (chemical mechanical polishing), an etching stopping layer may be disposed on the upper or bottom surface of the interconnect or interlayer insulating film. Moreover, the layer of an interlayer insulating film may be composed of plural layers which are not necessarily made of the same material.

The insulating film of the invention may be used as a stack structure with another Si-containing insulating film or organic film. It is preferably used as a stack structure with a hydrocarbon-based film.

The film obtained using the film forming composition of the invention can be etched for forming copper wiring or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, an ashing residue may be removed by washing.

The film obtained using the film forming composition of the invention may be subjected to CMP for planarizing a copper plated portion after copper wiring. As a CMP slurry (chemical solution), a commercially available one (for example, product of Fujimi Incorporated, Rodel Nitta, JSR or Hitachi Chemical) can be used as needed. As a CMP apparatus, a commercially available one (for example, product of Applied Material or Ebara Corporation) can be used as needed. After CMP, the film can be washed in order to remove therefrom the slurry residue.

The film available using the film forming composition of the invention can be used for various purposes. For example, it is suited as an insulating film for semiconductor devices such as LSI, system LSI, DRAM, SDRAM, RDRAM, and D-RDRAM, and for electronic parts such as multi-chip module multilayered wiring boards. More specifically, it is usable as an interlayer insulating film, etching stopper film, surface protective film, or buffer coat film for semiconductor, a passivation film or α-ray blocking film for LSI, a cover lay film or overcoat film in flexographic plate, a cover coat for flexible copper-lined plate, a solder resist film, or a liquid-crystal alignment film. It is also usable as a surface protective film, anti-reflection film or phase difference film for optical devices.

By the above-described process, an insulating film with a low dielectric constant, that is, an insulating film with a relative dielectric constant of 2.5 or less, preferably 2.3 or less is available.

### EXAMPLES

The present invention will hereinafter be described by Examples.

### Synthesis Example 1

Example compound (I-d) (1 g, product of Aldrich) was added to 80 g of butyl acetate. In a nitrogen gas stream, 5 mg of a solution obtained by diluting 5 mg of “V-601” (trade name; product of Wako Pure Chemicals, a 10-hour half-life temperature: 66° C.) with 4 ml of butyl acetate was added dropwise as a polymerization initiator over 2 hours while heating under reflux (internal temperature of 127° C.). After completion of the dropwise addition, the reaction mixture was heated under reflux for 1 hour. After addition of 20 mg of 4-methoxyphenol as a polymerization inhibitor, the resulting mixture was cooled to room temperature and then concentrated under reduced pressure to a liquid amount of 2 g. To the concentrate was added 20 ml of methanol and the mixture was stirred for 1 hour. The solid substance was then collected by filtration and dried. The solid substance was then dissolved in 10 ml of tetrahydrofuran. Water (1.8 ml) was added to the resulting solution while stirring. After stirring for 1 hour, the supernatant was removed by decantation and 10 ml of methanol was added. The resulting mixture was filtered, followed by drying to obtain 0.49 g of a solid substance. Analysis of the solid substance by GPC revealed that a component having a larger molecular weight than that of Example Compound (I-d) had Mw of 158,000, M_{z+1} of 310,000 and Mn of 89,000; the amount of Example Compound (I-d) which had remained unreacted in the solid substance was 3 mass % or less; and components having a molecular weight of 3,000,000 or greater were not contained. As a result of measurement of ¹H-NMR spectrum of a solid component while using deuterated chloroform as a measuring solvent, a proton peak derived from alkyl groups obtained by polymerization of vinyl groups and a proton peak derived from the remaining vinyl groups were observed with an integration ratio of 48:52, suggesting the occurrence of polymerization between vinyl groups.

By adding 5 ml of propylene glycol methyl ether acetate to 0.3 g of the resulting composition and stirring the mixture at 40° C. for 3 hours, a uniform solution of the composition was obtained. The uniform solution was filtered through a 0.2 μm-filter made of Teflon (trade mark), whereby Composition A of the invention was obtained.

It is apparent from the amount of the remaining monomer and the amount of the additives that the polymerized substance obtained by the reaction between vinyl groups of the monomers amounts to 70 mass % or greater of the solid component in the composition.

### Synthesis Example 2

Example compound (I-d) (1 g, product of Aldrich) was added to 26.4 g of butyl acetate. In a nitrogen gas stream, a solution obtained by diluting 1.8 mg of “V-601” (trade name; product of Wako Pure Chemicals, a 10-hour half-life temperature: 66° C.) with 2 ml of butyl acetate was added dropwise as a polymerization initiator over 2 hours while heating under reflux (internal temperature of 127° C.). After completion of the dropwise addition, the reaction mixture was heated under reflux for 1 hour. After addition of 20 mg of 4-methoxyphenol as a polymerization inhibitor, the resulting mixture was cooled to room temperature and then concentrated under reduced pressure to a liquid amount of 2 g. To the concentrate was added 20 ml of methanol and the mixture was stirred for 1 hour. The solid substance was then collected by filtration and dried. The solid substance was then dissolved in 15 ml of tetrahydrofuran. Water (5 ml) was added dropwise to the resulting solution while stirring. After stirring for 1 hour, the supernatant was discarded by decantation and 10 ml of methanol was added. The resulting mixture was filtered, followed by drying to obtain 0.60 g of a solid substance. Analysis of the solid substance by GPC revealed that components having a larger molecular weight than that of Compound (I-d) had Mn of 31,000, Mw of 118,000 and M_{z+1} of 270,000; the amount of Example Compound (I-d) which had remained unreacted in the solid substance was 3 mass % or less; and components having a molecular weight of 3,000,000 or greater were not contained. As a result of measurement of ¹H-NMR spectrum of a solid component while using deuterated chloroform as a measuring solvent, a proton peak derived from alkyl groups obtained by the polymerization of vinyl groups and a proton peak derived from the remaining vinyl groups were observed with an integration ratio of 42:58, suggesting the occurrence of the polymerization between the vinyl groups.

By adding 5 ml of propylene glycol methyl ether acetate to 0.3 g of the resulting composition and stirring the mixture at 40° C. for 3 hours, a uniform solution of the composition was obtained. The uniform solution was filtered through a 0.2 μm-filter made of Teflon (trade mark), whereby Composition B of the invention was obtained.

It is apparent from the amount of the remaining monomer and the amount of the additives that the polymerized product obtained by the reaction between vinyl groups of the monomers amounted to 70 mass % or greater of the solid component in the composition.

### Synthesis Example 3

Example compound (I-d) (1 g, product of Aldrich) was added to 13.2 g of butyl acetate. In a nitrogen gas stream, a solution obtained by diluting 1 mg of “V-40” (trade name; product of Wako Pure Chemicals, a 10-hour half-life temperature: 88° C.) with 1 ml of butyl acetate was added dropwise as a polymerization initiator over 4 hours while heating under reflux (internal temperature of 127° C.). After completion of the dropwise addition, the reaction mixture was heated under reflux for 1 hour. After addition of 20 mg of 4-methoxyphenol as a polymerization inhibitor, the resulting mixture was cooled to room temperature and then concentrated under reduced pressure to a liquid amount of 2 g. To the concentrate was added 20 ml of methanol and the mixture was stirred for 1 hour. The solid substance was then collected by filtration and dried. The solid substance was then dissolved in 10 ml of tetrahydrofuran. Water (1.8 ml) was added to the resulting solution while stirring. After stirring for 1 hour, the supernatant was discarded by decantation and 10 ml of methanol was added. The resulting mixture was filtered, followed by drying to obtain 0.41 g of a solid substance. Analysis of the solid substance by GPC revealed that components having a larger molecular weight than that of Example Compound (I-d) had Mw of 128,000, M_{z+1} of 380,000 and Mn of 33,000; the amount of Example Compound (I-d) which had remained unreacted in the solid substance was 3 mass % or less; and components having a molecular weight of 3,000,000 or greater were not contained. As a result of measurement of ¹H-NMR spectrum of a solid component while using deuterated chloroform as a measuring solvent, a proton peak derived from alkyl groups obtained by the polymerization of vinyl groups and a proton peak derived from the remaining vinyl groups were observed with an integration ratio of 53:47, suggesting the occurrence of polymerization between the vinyl groups.

By adding 5 ml of propylene glycol methyl ether acetate to 0.3 g of the resulting composition and stirring the mixture at 40° C. for 3 hours, a uniform solution of the composition was obtained. The uniform solution was filtered through a 0.2 μm-filter made of Teflon (trade mark), whereby Composition C of the invention was obtained.

It is apparent from the amount of the remaining monomer and the amount of the additives that the polymerized substance obtained by the reaction between vinyl groups of the monomers amounted to 70 mass % or greater of the solid component of the composition.

### Synthesis Example 4

### Comparative Example

Example Compound (I-d) (1 g, product of Aldrich) was added to 4 g of butyl acetate. In a nitrogen gas stream, a solution obtained by diluting 0.5 mg of “V-601” (trade name; product of Wako Pure Chemicals, a 10-hour half-life temperature: 66° C.) with 1 ml of butyl acetate was added dropwise as a polymerization initiator over 2 hours while heating under reflux (internal temperature of 127° C.). After completion of the dropwise addition, the reaction mixture was heated under reflux for 1 hour. After cooling to room temperature, the reaction mixture was concentrated under reduced pressure to a liquid amount of 2 g. To the concentrate was added 20 ml of methanol and the mixture was stirred for 1 hour. The reaction mixture was filtered, followed by drying to obtain 0.69 g of a solid substance. Analysis of the solid substance by GPC revealed that components having a larger molecular weight than that of Example Compound (I-d) had Mw of 378,000, M_{z+1} of 1091,000 and Mn of 9,000; the amount of Example Compound (I-d) which had remained unreacted and contained in the solid substance was 32 mass %; and 0.1%, in terms of an integration value of an RI detector, of components having a molecular weight of 3,000,000 or greater were contained.

Cyclohexanone (5 ml) was added to 0.3 g of the resulting composition and the mixture was stirred at 40° C. for 3 hours (Composition D).

Coated films (thickness: 300 nm) were formed respectively by applying Compositions A to D prepared in the above Synthesis Examples to a 4-inch silicon wafer by spin coating, drying the substrate at 130° C. for 1 minute and then at 200° C. for 1 minute on a hot plate, and then heating at 400° C. for 30 minutes in a clean oven in a nitrogen gas atmosphere.

The dielectric constant of these films was measured using a mercury probe manufactured by Four Dimensions (measured at 25° C.). A film thickness loss ratio was measured using a VASE® ellipsometer manufactured by J. A. WOOLLAM.

Evaluation results are shown in Table 1.

TABLE 1

| | | Film | Relative |
|---|---|---|---|
| | Conditions of coated surface | thickness | Dielectric |
| Composition | (visually observed) | loss | constant |
| A | Good | 0.97 | 2.17 |
| B | Good | 0.97 | 2.29 |
| C | Good | 0.98 | 2.27 |
| D (Comp. Ex.) | Poor (with many striations) | 0.83 | 2.71 |

Film thickness loss=(film thickness before heating at 400° C.—film thickness after heating at 400° C.)/film thickness after heating at 400° C.

The results shown in Table 1 suggest that use of the compositions of the invention makes it possible to provide films having a well coated surface, undergoing a small film thickness loss during baking and having a low dielectric constant.

The invention makes it possible to form a film suited for use as an interlayer insulating film in semiconductor devices or a low refractive index film in optical devices and excellent in uniformity of a film quality and film properties such as dielectric constant and Young's modulus.

The entire disclosure of each and every foreign patent application from which the benefit of foreign priority has been claimed in the present application is incorporated herein by reference, as if fully set forth.

What is claimed is:

1. An insulating film forming composition, comprising:
a polymerized substance obtained by dissolving a cage-type silsesquioxane compound having two or more unsaturated groups as substituents in an organic solvent to give a concentration of 12 mass % or less, and polymerizing the cage-type silsesquioxane compound in presence of a polymerization initiator,
wherein the polymerized substance obtained by reacting the cage-type silsesquioxane compound having two or more unsaturated groups as substituents totally amounts to 70 mass % or greater of a solid component contained in the insulating film forming composition.

2. The insulating film forming composition according to claim 1,
wherein the polymerization initiator is an azo compound.

3. The insulating film forming composition according to claim 1,
wherein the cage-type silsesquioxane compound which has remained unreacted in the insulating film forming composition amounts to 15 mass % or less.

4. The insulating film forming composition according to claim 1,
wherein an organic solvent used for polymerization is an ester-group-containing compound.

5. The insulating film forming composition according to claim 1,
wherein the cage-type silsesquioxane compound is a compound having m numbers of RSi (O_{0.5})₃ units, in which m stands for an integer from 8 to 16, and Rs each independently represents a nonhydrolyzable group, with the proviso that at least two of Rs are each a vinyl- or ethynyl-containing group, and
wherein the units are linked to each other via a common oxygen atom and constitute a cage structure.

6. The insulating film forming composition according to claim 5,
wherein at least two of Rs are vinyl groups.

7. The insulating film forming composition according to claim 6,
wherein Rs are all vinyl groups.

8. The insulating film forming composition according to claim 1,
wherein the polymerized substance is substantially free of a component having a molecular weight of 3,000,000 or greater.
